(19) United States
(12) Patent Application Publication
(10) Pub. No.: US 2008/0126590 A1
(43) Pub. Date: May 29, 2008

(54) Semiconductor based host protected addressing in computing devices

(76) Inventors: Michael A. Rothman, Puyallup, WA (US); Vincent J. Zimmer, Federal Way, WA (US)

Correspondence Address: Caven & Aghevli LLC;c/o Intellevate, P.O. Box 52050, Minneapolis, MN, 55402, US

(21) Appl. No.: 11/477,838

(22) Filed: Jun. 29, 2006

(51) Int. Cl. G06F 13/00

(52) U.S. Cl. 710/15

(57) ABSTRACT

In some embodiments, an apparatus may comprise a memory control hub, an input/output control hub coupled to the memory control hub, logic instructions stored in a computer readable medium which, when executed, configure the input/output hub to monitor input/output requests directed to one or more storage devices coupled to the input/output control hub, and redirect selected input/output requests to a semiconductor based memory module coupled to the memory control hub. Other embodiments may be described.

### BACKGROUND

The subject matter described herein relates generally to the field of electronic communication and more particularly to semiconductor based host protected addressing in computing devices.

Magnetic storage devices such as, e.g., disk drives, in computing systems may include one or more regions that are reserved for storing data that is not accessible to a user of the computing system. These regions may include one or more tracks of a disk drive, and may be used to store information used to help the disk drive cooperate with the operating system and with other components of the computing system. Typically the disk controller prevents users of the computing system from generating input/output (I/O) operations directed to the reserved area of the disk, a processes sometimes referred to as host protected addressing.

Disk-based host protected addressing suffers from certain deficiencies. For example, the amount of storage designated by the manufacturer may be inadequate. Further, disk controller-based solutions to protect regions of a disk drive can create compatibility problems with varying computing systems.

### BRIEF DESCRIPTION OF THE DRAWINGS

The detailed description is described with reference to the accompanying figures.

FIG. 1 is a schematic illustration of a computing system adapted to implement semiconductor based host protected addressing in accordance with some embodiments.

FIG. 2 is a schematic illustration of an architecture of a computer system adapted to implement semiconductor based host protected addressing in accordance with some embodiments.

FIGS. 3-4 are flowcharts illustrating host protected addressing operations which may be performed by the system of FIG. 1 or the device of FIG. 2 in accordance with some embodiments.

### DETAILED DESCRIPTION

Described herein are exemplary systems and methods for semiconductor based host protected addressing in computing devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

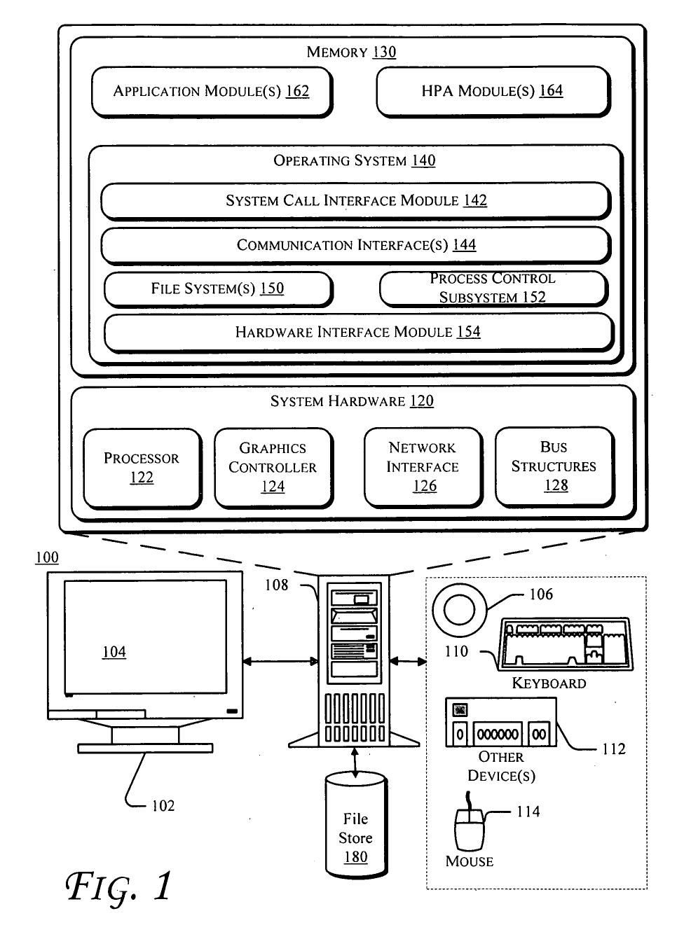

FIG. 1 is a schematic illustration of a system 100 adapted to perform semiconductor based host protected addressing operations. In some embodiments, system 100 includes a computing device 108 and one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track ball, and any other device that allows the system 100 to receive input from a user.

The computing device 108 includes system hardware 120 and memory 130. A file store 180 may be communicatively coupled to computing device 108. File store 180 may be internal to computing device 108 such as, e.g., one or more hard drives, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, video controllers 124, network interfaces 126, and bus structures 128. In one embodiment, processor 122 may be embodied as an Intel ® Pentium IV® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics controller 124 may function as an adjunction processor that manages graphics and/or video operations. Graphics controller 124 may be integrated onto the motherboard of computing system 100 or may be coupled via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT—Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In some embodiments, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may be implemented as one or more of non-volatile memory (such as, e.g., read-only memory (ROM), non-volatile random access memory (NVRAM), flash memory) and volatile memory (such as random access memory (RAM)). Memory 130 may include an operating system 140 for managing operations of computing device 108. In some embodiments, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Solaris, etc.) or as a Windows® brand operating system, or other operating systems.

In some embodiments, the computing device 108 may be embodied as a personal computer, a laptop computer, a personal digital assistant, a mobile telephone, an entertainment device, or another computing device.

In some embodiments, memory 130 may include one or more application modules 162. Memory 130 may further include one or more Host Protected Addressing (HPA) modules 164 to define an area in at least one of the memory 130 or the file system 180 of computing system that is protected from host input/output (I/O) operations.

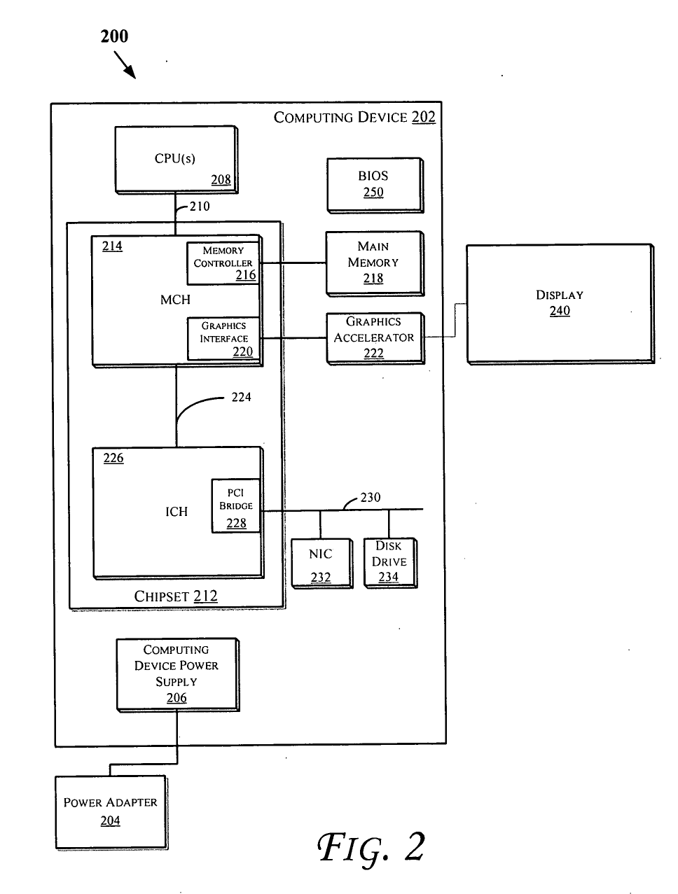

FIG. 2 is a schematic illustration of an architecture of a computer system adapted to implement semiconductor based host protected addressing in accordance with some embodiments. Computer system 200 includes a computing device 202 and a power adapter 204 (e.g., to supply electrical power to the computing device 202). The computing device 202 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 202 (e.g., through a computing device power supply 206) from one or more of the following sources: one or more battery packs, an alternating current (AC) outlet (e.g., through a transformer and/or adaptor such as a power adapter 204), automotive power supplies, airplane power supplies, and the like. In one embodiment, the power adapter 204 may transform the power supply source output (e.g., the AC outlet voltage of about 110 VAC to 240 VAC) to a direct current (DC) voltage ranging between about 7 VDC to 12.6 VDC. Accordingly, the power adapter 204 may be an AC/DC adapter.

The computing device 202 may also include one or more central processing unit(s) (CPUs) 208 coupled to a bus 210. In one embodiment, the CPU 208 may be one or more processors in the Pentium® family of processors including the Pentium® II processor family, Pentium® III processors, Pentium® IV processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 212 may be coupled to the bus 210. The chipset 212 may include a memory control hub (MCH) 214. The MCH 214 may include a memory controller 216 that is coupled to a main system memory 218. The main system memory 218 stores data and sequences of instructions that are executed by the CPU 208, or any other device included in the system 200. In some embodiments, the main system memory 218 includes random access memory (RAM); however, the main system memory 218 may be implemented using other memory types such as dynamic RAM (DRAM), synchronous DRAM (SDRAM), and the like. Additional devices may also be coupled to the bus 210, such as multiple CPUs and/or multiple system memories.

In some embodiments, main memory 218 may include a one or more flash memory devices. For example, main memory 218 may include either NAND or NOR flash memory devices, which may provide hundreds of megabytes, or even many gigabytes of storage capacity.

The MCH 214 may also include a graphics interface 220 coupled to a graphics accelerator 222. In one embodiment, the graphics interface 220 is coupled to the graphics accelerator 222 via an accelerated graphics port (AGP). In an embodiment, a display (such as a flat panel display) 240 may be coupled to the graphics interface 220 through, for example, a signal converter that translates a digital representation of an image stored in a storage device such as video memory or system memory into display signals that are interpreted and displayed by the display. The display 240 signals produced by the display device may pass through various control devices before being interpreted by and subsequently displayed on the display.

A hub interface 224 couples the MCH 214 to an input/output control hub (ICH) 226. The ICH 226 provides an interface to input/output (I/O) devices coupled to the computer system 200. The ICH 226 may be coupled to a peripheral component interconnect (PCI) bus. Hence, the ICH 226 includes a PCI bridge 228 that provides an interface to a PCI bus 230. The PCI bridge 228 provides a data path between the CPU 208 and peripheral devices. Additionally, other types of I/O interconnect topologies may be utilized such as the PCI Express™ architecture, available through Intel® Corporation of Santa Clara, Calif.

The PCI bus 230 may be coupled to a network interface card (NIC) 232 and one or more disk drive(s) 234. Other devices may be coupled to the PCI bus 230. In addition, the CPU 208 and the MCH 214 may be combined to form a single chip. Furthermore, the graphics accelerator 222 may be included within the MCH 214 in other embodiments.

Additionally, other peripherals coupled to the ICH 226 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like.

System 200 may further include a basic input/output system (BIOS) 250 to manage, among other things, the boot-up operations of computing system 200. BIOS 250 may be embodied as logic instructions encoded on a memory module such as, e.g., a flash memory module.

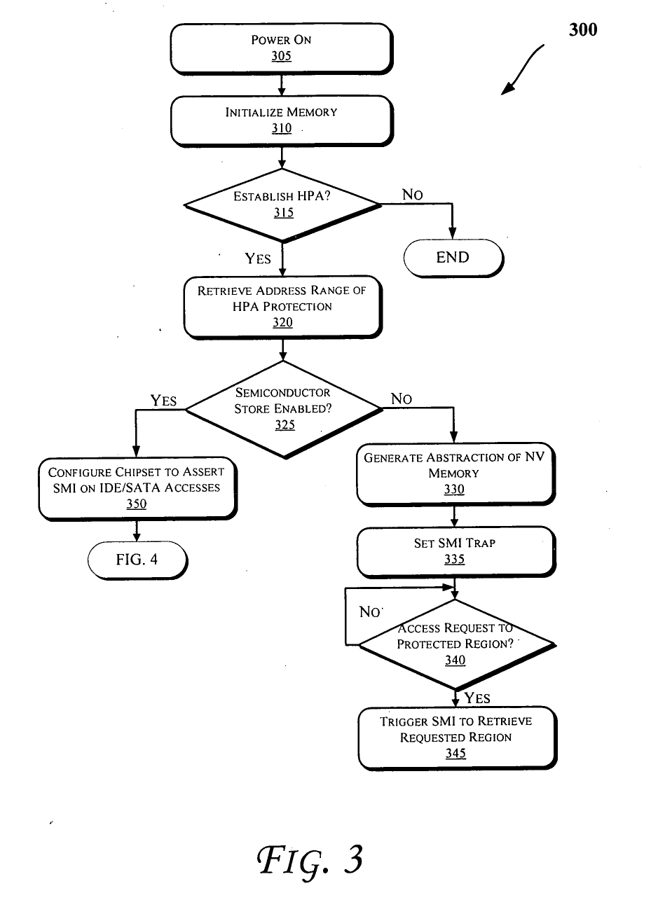

In one embodiment, a computing system such as system 100 or system 200 may implement semiconductor based host protected addressing. FIG. 3 is a flowchart illustrating operations performed by system 200 in accordance with an embodiment. In some embodiments, certain operations of FIG. 3 may be performed by the basic input/output system (BIOS) of computing system 200.

Referring to FIG. 3, at operation 305 the computing system 200 is powered on, and at operation 310 the computer system memory is initialized. In some embodiments, the memory may correspond to main memory module 218, and initializing the memory may comprise clearing memory space or setting memory locations to an initial value.

At operation 315, it is determined whether the computer system 200 is configured to implement host protected addressing. In some embodiments, host protected addressing may be implemented as a user-selectable option. In other embodiments, host protected addressing may be implemented by a manufacturer designer of the computer system, e.g., in the system BIOS 250. Host protected addressing may be indicted by storing an indicator in a non-volatile memory location that may be set to a first value that indicates host protected addressing should be implemented or to a second value that indicates host protected addressing should not be implemented.

If, at operation 315, host protected addressing is not implemented, then the operations of FIG. 3 may end. By contrast, if at operation 315 host protected addressing is implemented, then control passes to operation 320 and the address range of HPA protection is retrieved. In some embodiment, the address range of HPA protection may represent physical or logical blocks on a storage device such as, e.g., disk drive 234, may be stored in a non-volatile memory module of the computing system 200.

If, at operation 325 a semiconductor based backing store for the protected magnetic media is not implemented, then control passes to operation 330 and an abstraction of a non-volatile memory structure is generated. In some embodiments, computing system 200 may include a mass quantity such as, e.g., 500 megabytes to 8 gigabytes of non-volatile storage such as, e.g., flash memory. Generating an abstraction of the non-volatile memory may include assigning addresses to the physical storage space provided by the non-volatile memory. The addresses may be logical addresses or physical addresses.

At operation 335 a system management interface (SMI) SMI trap is set. In one embodiment, setting an SMI trap may include configuring the ICH 226 to trap I/O requests directed to addresses within the addressing scheme assigned to the non-volatile memory created in operation 330.

At operation 340, I/O operations to the non-volatile memory are monitored for I/O access requests to a protected region of the non-volatile memory. If, at operation 340 there is an I/O access request to a protected region of the non-volatile memory, then control passes to operation 345 and an SMI trap is triggered to retrieve data from the requested region. In some embodiments, a user-compliant action such as, e.g., striking a key sequence during the power-on sequence or in response to a prompt, may be required to trigger the SMI.

Operations 330-345 permit the computing system 200 to implement a simulated host protected addressing scheme in non-volatile memory such as, e.g., main memory module 218. In some embodiments, computing system 200 may include both a main memory 218 and a disk drive 234.

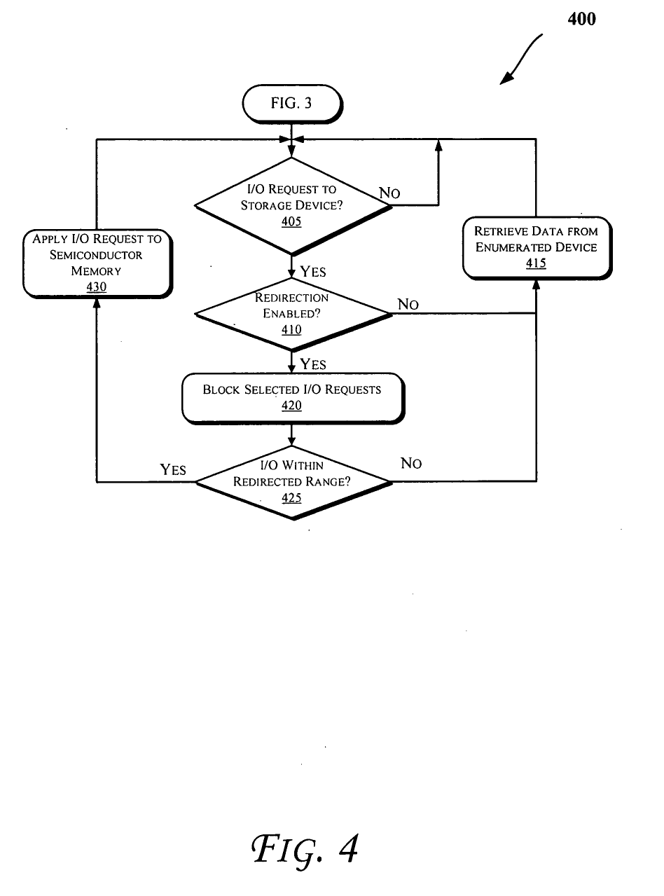

Referring back to operation 325, if a semiconductor store is enabled, then control passes to operation 350, and the chipset 212 is configured to assert an SMI trap on I/O access requests to integrate device electronics (IDE)/Serial Advanced Technology Attachment (SATA) devices coupled to chipset 212. In one embodiment, configuring the chipset 212 may include setting the ICH 226 to trap IDE/SATA I/O requests. Control then passes to the operations of FIG. 4.

Referring to FIG. 4, at operation 405 the ICH 226 monitors I/O access requests to a storage device such as, e.g., disk drive 234. If, at operation 405 an I/O access is received, then control passes to operation 410.

If, at operation 410 a redirection enablement directive has not been established for the device enumerated in the I/O access request, then control passes to operation 415 and the data requested in the I/O access request may be retrieved from the device enumerated in the I/O access request. For example, if an I/O access request enumerates the disk drive 234, then the I/O operation may be executed against the disk drive 234. Control then passes back to operation 405.

By contrast, if at operation 410 a redirection enablement directive has been established for the device enumerated in the I/O access request, then control passes to operation 420, at which selected I/O requests may be blocked. In some embodiments, access to the restricted portion of the device enumerated in the I/O request may be blocked based in part on factors such as, e.g., the entity that originated the I/O access request or the mode of the host protected addressing scheme.

If, at operation 425, the I/O access request is within the range of addresses that are covered by the redirection enablement directive, then control passes to operation 430 and the I/O access request is applied to the semiconductor memory such as, e.g., main memory 218. By contrast, if at operation 420 the I/O access request is not within the range of addresses covered by the redirection enablement directive, then control passes to operation 415 and the I/O access request is applied to the enumerated device. Control then passes back to operation 405.

In some embodiments, the operations of FIGS. 3-4 may be implemented as logic instructions stored on a computer-readable medium such as, e.g., the memory 130 of computer system 100 depicted in FIG. 1, or in the ROM 214 of the integrated circuit device 200 depicted in FIG. 2. The logic instructions, when executed by a processor such as the processor 122 or processor unit 216, configure the processor to perform the operations described in FIGS. 3-4. Hence, the memory modules and processor constitute structure for performing the operations. In some embodiments the logic instructions may be configured into a programmable device such as, for example, a field programmable gate array (FPGA), or reduced to hard-wired logic circuitry.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A system, comprising:
one or more processors;
a memory control hub coupled to the one or more processors;
an input/output control hub coupled to the memory control hub and the one or more processors;
a semiconductor based memory module coupled to memory control hub;
one or more storage devices coupled to the input/output control hub;
logic instructions stored in a computer readable medium coupled to the processor which, when executed, configure the input/output hub to:
monitor input/output requests directed to the one or more storage devices; and
redirect selected input/output requests to the semiconductor based memory module.

2. The system of claim 1, further comprising logic instructions which, when executed, configure the input/output control hub to determine whether a redirection enablement directive has been assigned to a storage device identified in the input/output request.

3. The system of claim 1, further comprising logic instructions which, when executed, configure the input/output control hub to trap a storage management interface assertion in the input/output control hub.

4. The system of claim 1, further comprising logic instructions which, when executed, configure the input/output hub to block access to selected portions of the one or more storage devices.

5. The system of claim 1, further comprising logic instructions which, when executed, configure the input/output hub to permit access to selected portions of the one or more storage devices.

6. The system of claim 1, wherein the semiconductor based memory module comprises at least one of non-volatile memory or volatile memory.

7. An apparatus, comprising:
a memory control hub;
an input/output control hub coupled to the memory control hub;
logic instructions stored in a computer readable medium which, when executed, configure the input/output hub to:
monitor input/output requests directed to one or more storage devices coupled to the input/output control hub; and
redirect selected input/output requests to a semiconductor based memory module coupled to the memory control hub.

8. The apparatus of claim 7, further comprising logic instructions which, when executed, configure the input/output control hub to determine whether a redirection enablement directive has been assigned to a storage device identified in the input/output request.

9. The apparatus of claim 7, further comprising logic instructions which, when executed, configure the input/output control hub to trap a storage management interface assertion in the input/output control hub.

10. The apparatus of claim 7, further comprising logic instructions which, when executed, configure the input/output hub to block access to selected portions of the one or more storage devices.

11. The apparatus of claim 7, further comprising logic instructions which, when executed, configure the input/output hub to permit access to selected portions of the one or more storage devices.

12. A method, comprising:
receiving, in an input/output control hub, an input/output request directed to one or more storage devices coupled to the input/output control hub;
redirecting selected input/output requests to a semiconductor based memory module coupled to a memory controller hub.

13. The method of claim 12, further comprising configuring the input/output control hub to determine whether a redirection enablement directive has been assigned to a storage device identified in the input/output request.

14. The method of claim 12, further comprising configuring the input/output control hub to trap a storage management interface assertion in the input/output control hub.

15. The method of claim 12, further comprising configuring the input/output hub to block access to selected portions of the one or more storage devices.

16. The method of claim 12, further comprising configuring the input/output hub to permit access to selected portions of the one or more storage devices.

17. A computer program product encoded on a computer readable medium comprising logic instructions which, when executed, configure a processor to:
receive, in an input/output control hub, an input/output request directed to one or more storage devices coupled to the input/output control hub;
redirect selected input/output requests to a semiconductor based memory module coupled to a memory controller hub.

18. The computer program product of claim 17, further comprising logic instructions which, when executed, configure the input/output control hub to determine whether a redirection enablement directive has been assigned to a storage device identified in the input/output request.

19. The computer program product of claim 17, further comprising logic instructions which, when executed, configure the input/output control hub to trap a storage management interface assertion in the input/output control hub.

20. The computer program product of claim 17, further comprising logic instructions which, when executed, configure the input/output hub to block access to selected portions of the one or more storage devices.

21. The computer program product of claim 17, further comprising logic instructions which, when executed, configure the input/output hub to permit access to selected portions of the one or more storage devices.
